(19) United States
(12) Patent Application Publication
(10) Pub. No.: US 2008/0122300 A1
(43) Pub. Date: May 29, 2008

(54) Motor

(76) Inventors: Hung Myong Cho, Gyeongsangnam-do (KR); Seong Hai Jeong, Gyeongsangnam-do (KR); Yeong Soo Kim, Gyeongsangnam-do (KR)

Correspondence Address: KED & ASSOCIATES, LLP, P.O. Box 221200, Chantilly, VA, 20153-1200, US

(21) Appl. No.: 10/592,267

(22) PCT Filed: Jan. 20, 2006
(86) PCT No.: PCT/KR06/00238

§ 371 Date: Sep. 24, 2007

(30) Foreign Application Priority Data
Jan. 24, 2005 (KR) 10-2005-0006265

(51) Int. Cl. H02K 5/22; H02K 5/04; H02K 3/32; H02K 11/00

(52) U.S. Cl. 310/43; 310/91; 310/71; 310/68 B; 310/45; 310/217; 310/52

(57) ABSTRACT

A motor adapted to rotate an element of an appliance, for example, a drum of a washing machine, is disclosed. The motor includes a rotating shaft which is rotatably mounted to a motor mounting member of an appliance, a rotor which includes magnets circumferentially arranged at a position radially spaced apart from a center of the rotating shaft by a predetermined distance such that N and S poles are alternately arranged, and a stator which includes a core made of metal, an insulator enclosing the core while allowing a surface of the core facing the magnets of the rotor to be outwardly exposed, the insulator being made of an insulating resin material, coils wound on the insulator, and a circular molded member formed in accordance with an insert molding method to enclose the insulator and the coils while allowing the surface of the core outwardly exposed through the insulator to be outwardly exposed.

### TECHNICAL FIELD

The present invention relates to a motor, and more particularly, to a motor which includes a stator fixedly mounted to a washing machine or the like, the stator having an improved structure capable of achieving an improvement in waterproofness and mountability.

### BACKGROUND ART

Generally, a motor is essentially used in a drum washing machine, a pulsator washing machine, a dryer, an air conditioner, or the like, to rotate a drum, a washing tub, a blowing fan, or the like.

For example, in a drum washing machine, a motor is arranged at the rear of a tub such that the motor is directly coupled to a shaft of a drum. In this case, accordingly, the drive power of the motor is directly transferred to the drum. As a result, it is possible to achieve an increase in rotating force while reducing loss of drive power.

An example of a conventional motor, which is applied to a drum washing machine, will be described in brief with reference to FIGS. 1 and 2.

As shown in FIG. 1, a tub 2 is disposed in a cabinet 1. A drum 3 is centrally disposed in the tub 2 such that the drum 3 is rotatable.

A motor, which includes a rotor 5 and a stator 6, is arranged at the rear of the tub 2. The stator 6 is fixedly mounted to a rear wall of the tub 2. The rotor 5 surrounds the stator 6, and has a shaft 4 extending through the tub 2 such that the shaft 4 is axially connected to the drum 3. Although not shown, magnets are arranged along an inner circumferential surface of the rotor 5 such that opposite polarities are alternately arranged.

A tub support (not shown), which is made of metal, is interposed between the rear wall of the tub 2 and the stator 6, in order to support the weight of the stator 6 and to maintain the concentricity of the stator 6. The tub support has a structure approximately similar to the profile of the rear wall of the tub 2. The tub support is fixed to the rear wall of the tub 2.

A door 7 is mounted to a front side of the cabinet 1. A gasket 8 is arranged between the door 7 and the tub 2.

A suspension spring 9a is arranged between the inner surface of the cabinet 1 at the top of the cabinet 1 and the outer surface of the tub 2 at the top of the tub 2, in order to support the tub 2. A friction damper 9b is arranged between the inner surface of the cabinet 1 at the bottom of the cabinet 1 and the outer surface of the tub 2 at the bottom of the tub 2, in order to attenuate vibrations generated at the tub 2 during a spin-drying operation.

FIG. 2 is a perspective view illustrating a structure of the stator 6 in the motor of FIG. 1. As shown in FIG. 2, the stator 6 includes a metal core 6a, an insulator 6b which encloses the core 6a, and is made of a resin material, and coils 6c mound around the insulator 6b.

The core 6a of the stator 6 includes a plurality of laminated unit cores. Each unit core is fabricated by pressing a metal plate, and includes a plurality of teeth 6aa, and a base 6ab connecting the teeth 6aa. The base 6ab has protrusions 6d respectively formed with coupling holes 6e.

However, the above-mentioned conventional motor has the following problems.

First, in the conventional motor, the coils of the stator are outwardly exposed. For this reason, when the motor is applied to an appliance using water, for example, a washing machine, there may be a problem in that water may come into contact with the stator unless the waterproofness of the motor is ensured, thereby causing the stator to be damaged.

Furthermore, the stator of the conventional motor is structured such that the core and insulator thereof are directly fixed to the tub of the washing machine. For this reason, bolt-coupling members must be provided at the core and insulator such that they are integrated with the core and insulator. Due to this structure, however, the structural modification of the core and insulator is greatly limited.

For example, where a spiral core is used for the core of the stator, in order to reduce the loss of the core material, it is necessary to form bolt-coupling holes in the insulator itself because it is difficult to form such bolt-coupling holes in the spiral core itself.

This will be described in more detail. In terms of a reduction in the material of the stator core, a so-called “spiral core” is useful which is fabricated by laminating portions of a metal plate including teeth and a base while spirally rotating the metal plate. In this case, however, there is a problem in that it is impossible to form coupling members, which are adapted to couple the stator to the tub, at the inside of the core such that the coupling members are protruded from the core. This is because the spiral core is fabricated by spirally bending a metal plate punched to have a strip shape.

If coupling members are formed at the inside of the spiral core such that the coupling members are protruded from the spiral core, it is impossible to bend the core because the core has an excessively large width at regions where the protrusions are present, respectively.

For this reason, where a spiral core is used in the conventional case, coupling members are provided only at the insulator which will enclose the spiral core. In this case, however, the insulator must have a sufficiently high strength to withstand the weights of the core, coils, etc. As a result, the material and structure of the insulator are limited, so that the fabrication of the stator becomes more difficult.

### DISCLOSURE OF INVENTION

### Technical Problem

An object of the present invention devised to solve the above-mentioned problems lies in providing a motor which includes a stator having an improved structure, thereby being capable of obtaining a superior waterproofness.

Another object of the present invention is to provide a motor which is structured to reduce the structural limitations of the core and insulator thereof, and to enable the stator thereof to be easily and stably fixed to an appliance using the motor, for example, a washing machine.

### Technical Solution

The objects of the present invention can be achieved by providing a motor comprising: a rotating shaft which is rotatably mounted to a motor mounting member of an appliance; a rotor which is centrally coupled to the rotating shaft such that the rotor is rotatable, and includes magnets circumferentially arranged at a position radially spaced apart from a center of the rotating shaft by a predetermined distance; and a stator which includes a core, an insulator enclosing the core while allowing a surface of the core facing the magnets of the rotor to be outwardly exposed, coils wound on the insulator, and a molded member enclosing the insulator and the coils while allowing the surface of the core outwardly exposed through the insulator to be outwardly exposed.

In accordance with the present invention, the stator constituting the motor is enclosed by the molded member made of an insulating resin material. Accordingly, it is possible to substantially prevent water from penetrating toward the coils in the stator, and thus, to achieve an enhancement in waterproofness.

In addition, the coupling portion for the stator is formed at the molded member such that they are integral, during the injection molding process for the molded member. Accordingly, it is unnecessary to form coupling portions at the insulator and core. As a result, it is possible to simplify the structures of the stator, core, and insulator, to minimize the structural limitations of the stator, core, and insulator, and to easily and stably achieve the coupling of the stator.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a longitudinal sectional view schematically illustrating a structure of a drum washing machine to which a conventional outer rotor type motor is applied;

FIG. 2 is a perspective view illustrating a structure of a stator in the conventional outer rotor type motor of FIG. 1;

FIG. 3 is a longitudinal sectional view schematically illustrating a structure of a motor according to the present invention;

FIG. 4 is an exploded perspective view illustrating the motor of FIG. 3;

FIG. 5 is a perspective view illustrating the stator of the motor shown in FIG. 3, taken in a direction different from that of FIG. 4;

FIG. 6 is a perspective view illustrating a structure from which a molded member of the stator shown in FIG. 5 is removed;

FIG. 7 is an exploded perspective view illustrating a structure from which the molded member of the stator shown in FIG. 5 is removed;

FIG. 8 is an exploded perspective view similar to FIG. 7, illustrating another embodiment of the stator in the motor according to the present invention; and

FIG. 9 is an exploded perspective view illustrating another embodiment of a core in the motor according to the present invention.

### BEST MODE FOR CARRYING OUT THE INVENTION

Reference will now be made in detail to the preferred embodiments of the present invention, examples of which are illustrated in the accompanying drawings.

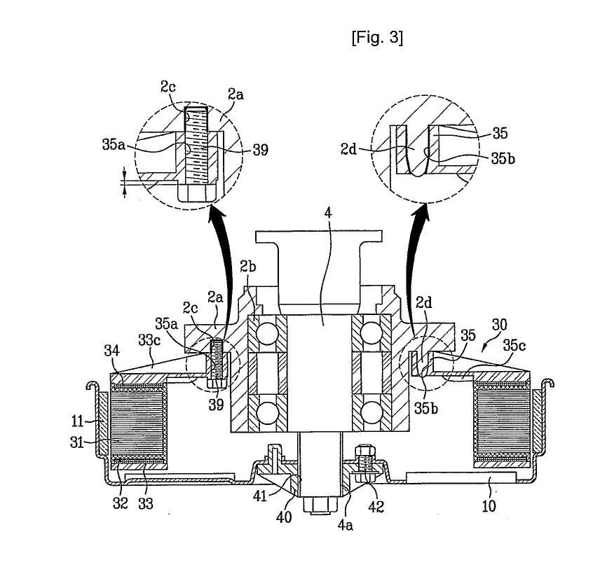

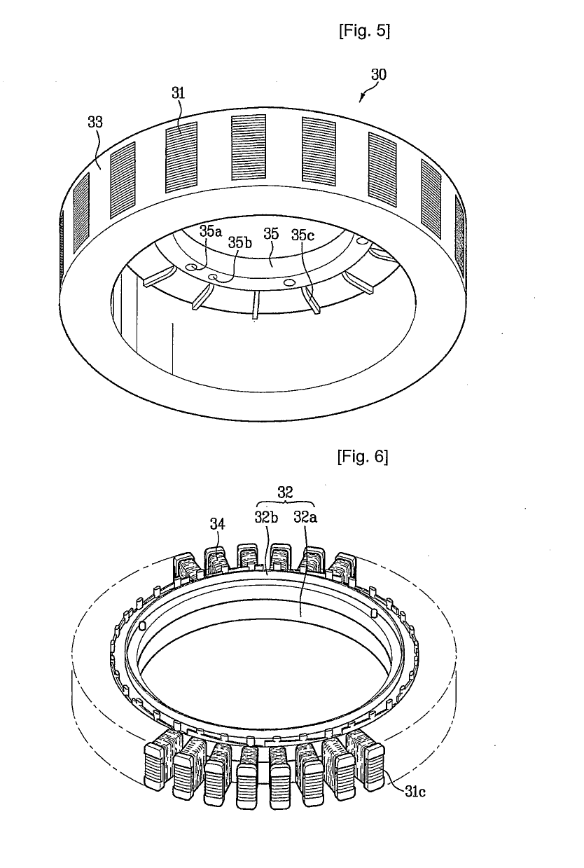

First, a motor according to an exemplary embodiment of the present invention will be described with reference to FIGS. 3 to 7.

For better understanding of the present invention, the following description will be given in conjunction with the case in which the motor of the present invention is applied to a drum washing machine. However, the motor of the present invention is also applicable to a pulsator washing machine, a dryer, an air conditioner, etc., equally or similarly to the drum washing machine.

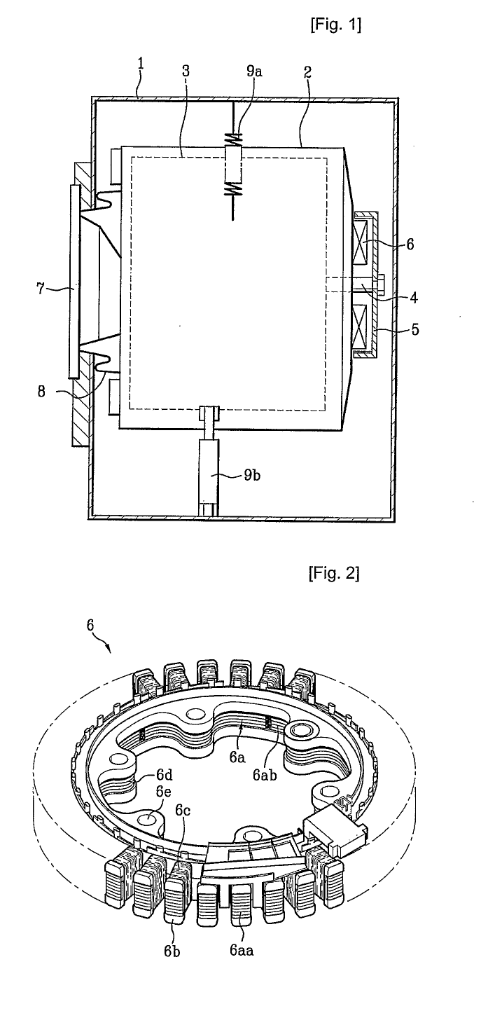

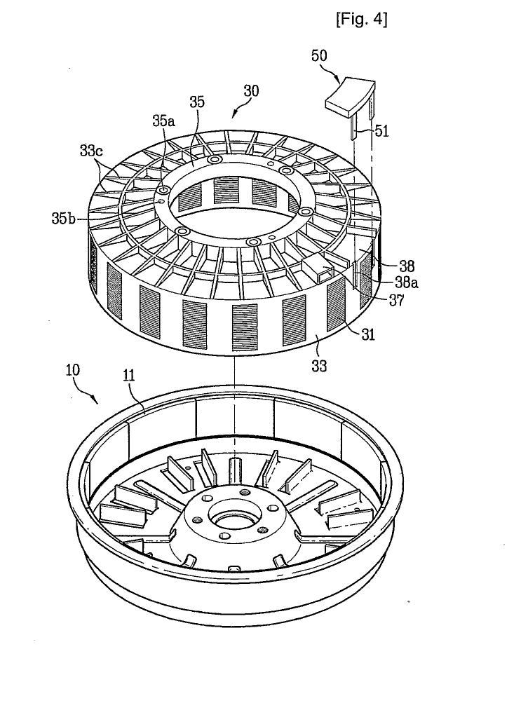

As shown in FIGS. 3 and 4, a rotating shaft 4 is rotatably mounted at a central portion of the rear wall of a tub 2 (FIG. 1) in the washing machine. The rotating shaft 4 is rotatably supported by a bearing 2b fitted in a bearing housing 2a mounted to the rear wall of the tub 2.

A motor, which is adapted to drive the rotating shaft 4, is mounted to the bearing housing 2a. The motor includes a stator 30 fixed to the bearing housing 2a, and a rotor 10 arranged around the stator 30 while being spaced apart from the stator 30 by a pre-determined gap. The rotor 10 has a central portion coupled to an end of the rotating shaft 4. Preferably, the rotor 10 is made of metal. Of course, the rotor 10 may be molded using a resin material.

The rotor 10 has a 90°-bent circumferential portion. A plurality of magnets 11 are arranged along the circumferential portion of the rotor 10 such that N and S-poles are alternately arranged.

A busing 40, which is made of a resin material, is coupled to the central portion of the rotor 10. The busing 40 is fitted around the rotating shaft 4. The coupling of the busing 40 to the central portion of the rotor 10 is achieved by fasteners such as bolts 42. Of course, the busing 40 may be formed integrally with the rotor 10, using an insert molding method.

The busing 40 is centrally provided with a hole in which the rotating shaft 4 is fitted. Serrations 41 are formed at the inner surface of the hole. The serrations 41 are engaged with serrations 4a formed at the outer surface of the rotating shaft 4.

Meanwhile, as shown in FIGS. 3 to 5, the stator 30 includes a core 31, an insulator 32 which encloses the core 31, and is made of an insulating resin material, coils 34 which are wound around the insulator 32, and a molded member 33 which is molded using an insert molding method to enclose the constituent elements of the stator substantially forming an electric field, namely, the insulator 32 and coils 34, and thus, to integrally support the constituent elements.

The molded member 33 of the stator 30 has a cylindrical shape, and has windows formed through the circumferential wall of the molded member 33 facing the magnets 11 such that the outer surface of the core 31 is outwardly exposed through the windows.

The molded member 33 is also provided, at an end thereof adjacent to the bearing housing 2a, with a coupling portion 35 for coupling the molded member 33 to the bearing housing 2a. The coupling portion 35 extends radially inwardly from the end of the molded member 33 such that the coupling portion 35 is integral with the molded member 33. Of course, the coupling portion 35 may extend radially outwardly from the outer peripheral edge of the molded member 33 such that the coupling portion 35 is integral with the molded member 33.

A plurality of uniformly spaced coupling holes 35a are formed through the inner end of the coupling portion 35 at positions corresponding to bolt coupling holes 2c formed at the bearing housing 2a, respectively.

The stator 30 must be coupled while maintaining an accurate concentricity with respect to the rotating shaft 4. To this end, a plurality of uniformly spaced positioning protrusions 2d are arranged near selected ones of the bolt coupling holes 2c of the bearing housing 2a, respectively, as shown in FIG. 3. Also, positioning grooves 35b are formed at the coupling portion 35 of the molded member 33 at positions corresponding to the positioning protrusions 2d such that the positioning protrusions 2d can be fitted in the positioning grooves 35b, respectively. The positioning grooves 35b may be formed at the coupling portion 35 in the form of through holes.

Of course, the positioning grooves may be formed at the bearing housing 2a, and the positioning protrusions may be formed at the coupling portion 35, reversely to the above-described case.

Each positioning protrusion 2d includes a protrusion body having a uniform diameter, and a guide portion formed at an end of the protrusion body, and having an approximately conical shape, so as to enable the positioning protrusion 2d to be easily inserted into the associated positioning groove 35b. Preferably, the positioning groove 35b has a shape and a size approximately identical to those of the positioning protrusion 2d so that the positioning protrusion 2d is tightly fitted in the positioning groove 35b after the insertion thereof. That is, the portion of the positioning groove 35b, in which the body portion of the positioning protrusion 2d is received, preferably has a uniform diameter corresponding to that of the body portion, and the portion of the positioning groove 35b, in which the guide portion of the positioning protrusion 2d is received, preferably has a conical shape corresponding to that of the guide portion.

Preferably, each positioning groove 35b of the coupling portion 35 has a diameter smaller than that of the associated coupling hole 35a.

It is also preferred that the coupling portion 35 be slightly protruded at a region around each coupling hole 35a, specifically, a region where the coupling portion 35 comes into contact with a head of a bolt 39 received in the coupling hole 35a, as compared to other regions of the coupling portion 35.

As shown in FIG. 4, a plurality of reinforcing ribs 33c are formed at the outer surface of the molded member 33 such that the reinforcing ribs 33c are integral with the molded member 33, in order to increase the strength of the molded member 33. Preferably, each reinforcing rib 33c extends to the coupling portion 35 of the molded member 33.

In order to increase the strength of the coupling portion 35 in the molded member 33, a plurality of reinforcing ribs 35c are preferably formed at the inner surface of the coupling portion 35. Of course, in place of the reinforcing ribs 33c and 35c, a reinforcing bracket (not shown), which is made of metal and has an annular shape, may be attached to the inner or outer surface of the molded member 33, in order to increase the strength of the molded member 33.

A connector 37 is formed at the molded member 33 such that they are integral, in order to supply electric power to each coil 34.

A Hall sensor mounting portion 38 is formed at a desired portion of the molded member 33, in order to mount a Hall sensor unit 50 for detecting the positions of the magnets 11 of the rotor 10. In the vicinity of the Hall sensor mounting portion 38, fitting grooves 38a are formed in which respective sensor terminals 51 of the Hall sensor unit 50 are fitted such that they are not radially outwardly protruded from the molded member 33.

Although not shown, a plurality of cooling holes are preferably formed through the molded member 33. The cooling holes communicate with the outside of the molded member 33, so as to outwardly discharge heat generated during operation of the motor.

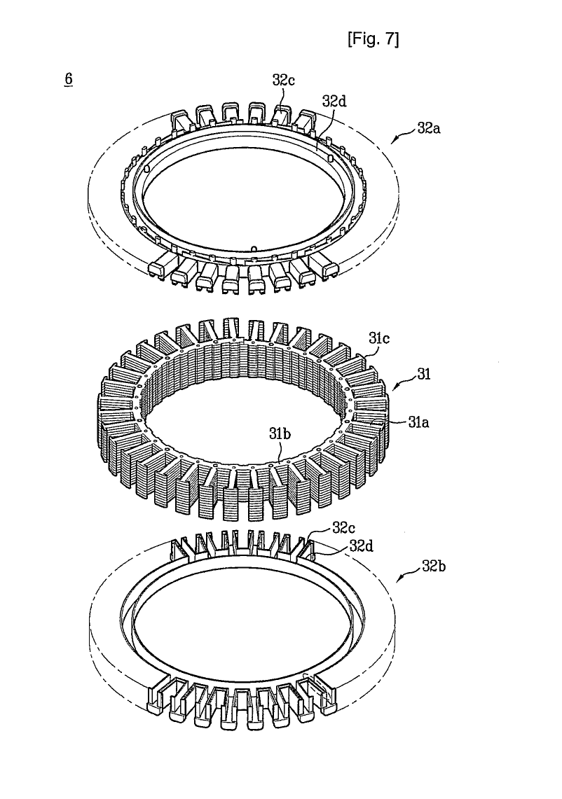

As shown in FIGS. 6 and 7, the core 31 of the stator 30 includes a plurality of teeth 31a, and a circular base 31b connecting the teeth 31a. In the illustrated embodiment of the present invention, application of a spiral core is illustrated. The spiral core is formed by spirally laminating portions of a strip-shaped metal plate having teeth and a circular base, as described above. For the core 31, a cylindrical core may be used, in place of the spiral core. The cylindrical core may be formed by laminating circular metal plates each punched to have a plurality of teeth and a base. In addition, as shown in FIG. 9, a plurality of core segments 231a may be used to form a completely-circular core 231. In this case, a plurality of arc-shaped metal plates, each of which includes a plurality of teeth 231b and an arc-shaped base 231c connecting the teeth 231b, are laminated to form each core segment 231a. The circular core 231 is formed by connecting the core segments 231a.

As shown in FIGS. 6 and 7, the insulator 32, which encloses the core 31, is divided into two portions, namely, a lower insulator 32a, and an upper insulator 32b arranged over the lower insulator 32a, and coupled to the lower insulator 32a. The coupling of the lower and upper insulators 32a and 32b may be achieved using a well-known hook coupling method. Of course, the insulator 32 may be formed to have an integral structure enclosing the core 31, using an insert molding method.

Each of the upper and lower insulators 32a and 32b has tooth receiving portions 32c which receive respective teeth 31a of the core 31, and a connecting portion 32d which connects the inner ends of the tooth receiving portions 32c, and receives the base 31b of the core 31.

Each tooth receiving portion 32c of the lower or upper insulator 32a or 32b has an open outer end such that the outer end of the tooth 31a received in the tooth receiving portion 32c, namely, a shoe 31c, is outwardly exposed through the tooth receiving portion 32c.

The coil 34 wound around each core receiving portion 32c of the insulator 32 may be made of an enamel-coated copper wire.

The stator 30 having the above-described structure is assembled, as follows.

First, the core 31 is seated in the lower insulator 32a. Next, the upper insulator 32b is coupled to the lower insulator 32a such that the core 31 is interposed between the lower and upper insulator 32a and 32b. Thereafter, coils 34 are mound around the tooth receiving portions 32c of the insulator 32, using a coil under.

The insulator 32, on which the coils 34 have been wound, is placed in a mold. An insulating resin material is then injected into the mold, thereby forming the molded member 33. In this case, it is preferred that the resin material of the molded member 33 have a melting point lower than the melting point of the enamel of the coils 34 and the melting point of the material of the insulator 32, in order to prevent the resin material of the molded member 33 from damaging the enamel coating of the coils 34 and the insulator 32 during the molding process.

Thereafter, an external power source is connected to the connector 37 of the molded member 33, and the Hall sensor unit 50 is mounted to the Hall sensor mounting portion 38 of the molded member 33. Thus, the stator 30 is completely assembled.

After the assembly of the stator 30 is completed, as described above, the operator accurately aligns the position of the molded member 33 with respect to the bearing housing 2a by fitting the positioning grooves 35b of the coupling portion 35 around the positioning protrusions 2d of the bearing housing 2a, respectively. Subsequently, the operator fastens bolts 39 through the coupling holes 35a of the coupling portion 35 and the bolt coupling holes 2c of the bearing housing 2a, thereby causing the molded member 33 to be coupled to the bearing housing 2a. Thus, the stator 30 is fixedly mounted to the bearing housing 2a fixed to the washing machine.

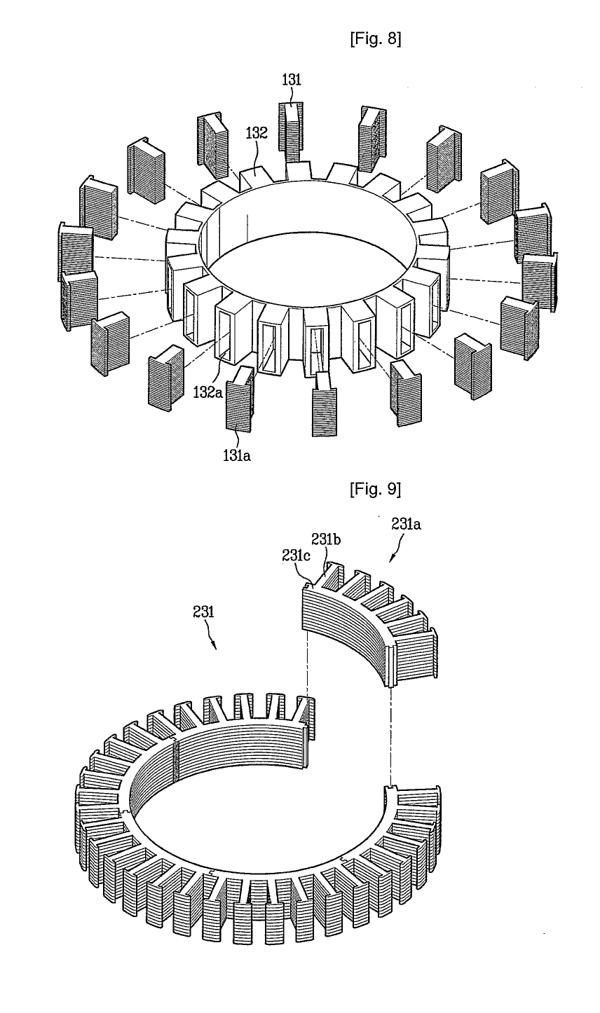

Meanwhile, in the above description given in association with the embodiment of the motor, the spiral core, cylindrical core, and divided core, each of which includes teeth 31a or 231b, and a base 31b or 231c connecting the teeth 31a or 231b, have been described for the core 31 of the stator 30. However, the core constituting the stator 30 may be constituted by divided core members 131 corresponding to respective teeth of the core, as shown in FIG. 8. In this case, each divided core member 131 may have a T-shaped structure in which outer and inner portions of the divided core member 131 have different widths, respectively, or may have an I-shaped structure in which the outer and inner portions of the divided core member 131 have the same width.

Where the core is constituted by the divided core members 131, an insulator 132 is provided which includes core receiving grooves 132a each having an open outer end to receive an associated one of the divided core members 131. In this case, there is an advantage in that the insulator 132 enclosing the divided core members 131 can be injection-molded into an integral structure without being divided into two portions. Of course, the insulator may be divided into upper and lower portions to be coupled together, as in the above-described embodiment.

Differently from this embodiment, the insulator may be constituted by divided insulator members which are separate from one another. In this case, there is an advantage in that high-speed winding can be achieved because there is no interference among the divided insulator members during the winding of the coils 34 (FIG. 6) by virtue of the fact that the insulator members are separate from one another, similarly to the divided core members 131.

Meanwhile, although the stator 30 of the motor has been described as being mounted to the bearing housing 2a of the washing machine in the above-described embodiments of the motor, the stator 30 may be fixed to the rear wall of the tub 2 (FIG. 1), or may be mounted to another portion of the washing machine while being concentric to the rotating shaft 4.

The motor of the present invention exhibits superior performance when it is applied to a washing machine because the stator itself has superior waterproofness by virtue of the molded member 33. However, the motor of the present invention may also be applicable to an air conditioner or other appliances in a manner identical or similar to that of the above-described case.

The motor described in association with each embodiment of the present invention is of an outer rotor type in which the magnets 11 are arranged around the stator 30 while being uniformly spaced apart from one another such that the magnets 11 are rotated around the stator 30. The present invention may be applicable to an inner rotor type motor in which the magnets 11 are arranged inside the stator 30 while being uniformly spaced apart from one another such that the magnets 11 are rotated along the stator 30 inside the stator 30.

Of course, where the motor is of an inner rotor type, the inner end of the core 31 must be exposed through the inner peripheral wall of the molded member 33.

As apparent from the above description, in accordance with the present invention, the stator constituting the motor is enclosed by the molded member made of an insulating resin material. Accordingly, it is possible to substantially prevent water from penetrating toward the coils in the stator, and thus, to achieve an enhancement in waterproofness.

In addition, the coupling portion for the stator is formed at the molded member such that they are integral, during the injection molding process for the molded member. Accordingly, it is unnecessary to form coupling portions at the insulator and core. As a result, it is possible to simplify the structures of the stator, core, and insulator, to minimize the structural limitations of the stator, core, and insulator, and to easily and stably achieve the coupling of the stator.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The motor of the present invention can be applied not only to a drum washing machine, but also to other appliances such as a pulsator washing machine, a dryer, and an air conditioner in a manner identical or similar to that of the drum washing machine.

1. A motor comprising:
a rotating shaft which is rotatably mounted to a motor mounting member of an appliance;
a rotor which is centrally coupled to the rotating shaft such that the rotor is rotatable, and includes magnets circumferentially arranged at a position radially spaced apart from a center of the rotating shaft by a predetermined distance; and
a stator which includes a core, an insulator enclosing the core while allowing a surface of the core facing the magnets of the rotor to be outwardly exposed, coils wound on the insulator, and a molded member enclosing the insulator and the coils while allowing the surface of the core outwardly exposed through the insulator to be outwardly exposed.

2. The motor according to claim 1, wherein the core is made of a metal material, and the insulator and the molded member are made of an insulating resin material.

3. The motor according to claim 1, wherein the molded member includes a coupling portion which is adapted to couple the molded member to the motor mounting member, and is formed integrally with the molded member.

4. The motor according to claim 3, wherein the coupling portion extends radially inwardly from an end of the molded member.

5. The motor according to claim 3, wherein the coupling portion extends radially outwardly from an end of the molded member.

6. The motor according to claim 3, wherein the motor mounting member includes a plurality of coupling holes, and the coupling portion includes a plurality of coupling holes respectively corresponding to the coupling holes of the motor mounting member, whereby the molded member of the stator is coupled to the motor mounting member when bolts are fastened through the coupling holes of the motor mounting member and coupling portion.

7. The motor according to claim 6, wherein the coupling portion is protruded at a region around each coupling hole of the coupling portion where the coupling portion comes into contact with a head of the bolt received in the coupling hole, as compared to other regions of the coupling portion.

8. The motor according to claim 3, further comprising:
a positioning unit which determines a position of the molded member to be fixed with respect to the motor mounting member.

9. The motor according to claim 8, wherein the positioning unit includes:
at least one positioning protrusion formed at the motor mounting member; and
at least one positioning groove formed at the coupling portion of the molded member such that the positioning groove receives the positioning protrusion.

10. The motor according to claim 8, wherein the positioning unit includes:
at least one positioning protrusion formed at the coupling portion of the molded member; and
at least one positioning groove formed at the motor mounting member such that the positioning groove receives the positioning protrusion.

11. The motor according to claim 9, wherein the positioning protrusion includes a protrusion body which has a uniform diameter, and a guide portion which is formed at an end of the protrusion body, and has a conical shape.

12. The motor according to claim 11, wherein the positioning groove includes a straight portion which has a uniform diameter, and corresponds to the protrusion body of the positioning protrusion, and an inclined portion which is formed at an end of the straight portion to have a conical shape, and corresponds to the guide portion of the positioning protrusion.

13. The motor according to claim 9, wherein the positioning groove has a diameter smaller than a diameter of the coupling holes of the coupling portion.

14. The motor according to claim 1, further comprising:
a reinforcing member which increases a strength of the molded member.

15. The motor according to claim 14, wherein the reinforcing member comprises a plurality of reinforcing ribs formed at an outer surface of the molded member such that the reinforcing ribs are integral with the molded member.

16. The motor according to claim 3, wherein the coupling portion of the molded member includes a plurality of reinforcing ribs for increasing a strength of the molded member.

17. The motor according to claim 3, further comprising:
an annular reinforcing bracket which is made of a metal material, and is mounted to a region where the coupling portion is connected to the molded member, to reinforce the coupling portion of the molded member.

18. The motor according to claim 1, further comprising:
a connector which is formed at the molded member such that the connector is integral with the molded member, and is adapted to supply electric power to the coils.

19. The motor according to claim 1, further comprising:
a Hall sensor which is mounted to the molded member, and is adapted to detect positions of the magnets of the rotor.

20. The motor according to claim 1, wherein the coils are made of an enamel-coated copper wire.

21. The motor according to claim 20, wherein the molded member is made of a resin material having a melting point lower than a melting point of the enamel of the coils, and a melting point of the insulator.

22. The motor according to claim 1, wherein the core comprises divided core members which are separate from one other.

23. The motor according to claim 22, wherein each of the divided core members has a T-shaped structure.

24. The motor according to claim 22, wherein each of the divided core members has an I-shaped structure.

25. The motor according to claim 22, wherein each of the divided core members is divided into at least to portions which are coupled together in the insulator.

26. The motor according to claim 1, wherein the core is a cylindrical core which is formed by laminating a plurality of metal plates each including a plurality of teeth respectively having one-side surfaces facing the magnets of the rotor, and a circular base connecting the other-side surfaces of the teeth.

27. The motor according to claim 1, wherein the core is a spiral core which is formed by laminating portions of a strip-shaped metal plate while spirally rotating the metal plate, the metal plate including a plurality of teeth respectively having one-side surfaces facing the magnets of the rotor, and a base connecting the other-side surfaces of the teeth.

28. The motor according to claim 1, wherein the core comprises a plurality of divided core members, each of which is formed by laminating a plurality of metal plates each including a plurality of teeth respectively having one-side surfaces facing the magnets of the rotor, and an arc-shaped base connecting the other-side surfaces of the teeth, the divided core members being connected together to form a circular structure.

29. The motor according to claim 22, wherein the insulator comprises divided insulator members which are separate from one another, to receive the divided core members, respectively.

30. The motor according to claim 22, wherein the divided insulator members are connected together.

31. The motor according to claim 30, wherein the divided insulator members are connected together at inner ends of the divided insulator members.

32. The motor according to claim 30, wherein the divided insulator members are connected together at outer ends of the divided insulator members.

33. The motor according to claim 1, wherein the insulator comprises a first insulator which receives a portion of the core, and a second insulator which receives the remaining portion of the core, and is coupled to the first insulator.

34. The motor according to claim 1, wherein the rotor is of an outer rotor type in which the magnets are arranged around the stator while being uniformly spaced apart from one another such that the magnets are rotated around the stator.

35. The motor according to claim 1, wherein the rotor is of an inner rotor type in which the magnets are arranged inside the stator while being uniformly spaced apart from one another such that the magnets are rotated along the stator inside the stator.

36. The motor according to claim 1, further comprising:
at least one cooling hole which is formed through the molded member, to communicate with the outside of the molded member.

37. The motor according to claim 1, wherein the appliance is a washing machine.
